(19) United States
(12) Patent Application Publication
(10) Pub. No.: US 2017/0222352 A1
(43) Pub. Date: Aug. 3, 2017

(54) CONNECTOR UNIT, SUB-CONNECTOR WITH FRAME AND SUB-CONNECTOR WITH CAP

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Shigeto Kato, Yokkaichi, Mie (JP)

(21) Appl. No.: 15/328,585

(22) PCT Filed: Jul. 9, 2015
(86) PCT No.: PCT/JP2015/069714

§ 371 Date: Jan. 24, 2017

(30) Foreign Application Priority Data
Jul. 30, 2014 (JP) 2014-154534

(51) Int. Cl. H01R 13/502; H01R 13/04

(52) U.S. Cl. CPC H01R 13/502; H01R 13/04

(57) ABSTRACT

A connector unit (30) is configured to be connectable to a mating connector (10). The connector unit (30) includes a plurality of sub-connectors (40, 50, 60) and a frame (32). Each of the sub-connectors (40, 50, 60) includes a connector housing (42, 52, 62) and male terminals (46, 56, 66) held by the connector housing with male terminal portions (47, 57, 67) projecting out from the connector housing. The frame (32) includes a uniting frame portion (34) for holding the plurality of sub-connectors in a united state with the male terminal portions of the plurality of sub-connectors facing in the same direction and a surrounding frame portion (36) for surrounding the male terminal portions of the plurality of sub-connectors.

### BACKGROUND

1. Field of the Invention

This invention relates to a technique for collectively connecting a plurality of sub-connectors to another connector.

2. Description of the Related Art

Japanese Unexamined Patent Publication No. H08-106949 discloses a split connector that includes a male frame and a female frame paired with each other and in which male sub-connectors having male terminal fittings mounted therein and female sub-connectors having female terminal fittings mounted therein are accommodated in a plurality of accommodation holes formed in the corresponding frames. The corresponding male and female sub-connectors are fit and connected by displacing the frames in directions toward each other by a connecting member provided between the frames.

The above-described male sub-connector has a substantially rectangular parallelepiped outer shape and a fitting recess is formed on the upper surface of the male sub-connector for receiving a fitting protrusion of the mating female sub-connector. Unillustrated cavities are formed in alignment in each male sub-connector, and the male terminal fitting is mounted in each cavity with a tab thereof projecting into the fitting recess.

In Japanese Unexamined Patent Publication No. H08-106949, the fitting recess is formed in each of the male sub-connectors. The fitting recess functions to protect the tabs of the male terminal fittings and guide the fitting protrusion of the female sub-connector.

Further, the assembly of the female sub-connectors, each including the fitting protrusion fittable into the fitting recess, is used as a mating connector. Thus, the mating connector is largely restricted.

Accordingly, an object of the present invention is to enable restrictions on a mating connector to be reduced in the case of configuring a connector unit by combining a plurality of sub-connectors including male terminals.

### SUMMARY

To solve the above problem, a first aspect of the present invention is directed to a connector unit to be connected to a mating connector. The connector unit has a plurality of sub-connectors, with each sub-connector including a connector housing and at least one male terminal held by the connector housing so that a male terminal portion projects out from the connector housing. The connector unit further has a frame including a uniting frame portion for holding the plurality of sub-connectors in a united state with the male terminal portions of the sub-connectors facing in the same direction and a surrounding frame portion for surrounding the male terminal portions of the sub -connectors.

The frame of the connector unit may be formed integrally to any one of the plurality of sub-connectors. With this arrangement, at least one other sub-connector can be incorporated into the frame that is formed integrally to the sub-connector.

The sub-connector integrally formed to the frame may be mountable on a mounting board. With this arrangement, the sub-connector mountable on the mounting board and the other sub-connector can be combined.

The invention also is directed to a sub-connector with a frame including a connector housing. At least one male terminal is held by the connector housing so that a male terminal portion projects out from the connector housing. A frame is formed integrally to the connector housing and includes a uniting frame portion for holding the connector housing and another connector housing in a united state. A surrounding frame portion surrounds the male terminal portion projecting from the connector housing and a male terminal portion projecting from the other connector housing. With this arrangement, the other sub-connector can be incorporated into the frame that is formed integrally to the sub-connector.

The invention further relates to a sub-connector with cap including a connector housing, at least one male terminal held by the connector housing with a male terminal portion projecting out from the connector housing, and a cap for covering the male terminal portion projecting from the connector housing. The cap is formed with a hole enabling an external terminal to come into contact with the male terminal portion. With this arrangement, the male terminal portions can be protected before the sub-connector is incorporated into the frame. Further, a continuity check or the like through the male terminal can be carried out through the hole formed in the cap.

### Effects

According to the above-described embodiments, the connector unit can be configured by combining the plurality of sub-connectors including the male terminals by the uniting frame portion of the frame. At this time, the surrounding frame portion of the frame surrounds the male terminal portions of the plurality of sub-connectors. This surrounding frame portion can function to protect the male terminal portions and guide the mating connector. Thus, the mating connector need not have a split structure or the like corresponding to the plurality of sub-connectors and restrictions on the mating connector can be reduced.

### BRIEF DESCRIPTION OF THE DRAWINGS

FIG. 1 is a schematic perspective view showing a connector unit according to an embodiment.

FIG. 2 is a schematic exploded perspective view of the connector unit.

FIG. 3 is a schematic section along of FIG. 2.

FIG. 4 is a schematic perspective view showing sub-connectors with caps according to a first modification.

FIG. 5 is a schematic section showing the sub-connector with cap according to the first modification.

FIG. 6 is a schematic perspective view showing a sub-connector with cap according to a second modification.

FIG. 7 is a schematic perspective view showing a connector unit according to a third modification.

### DETAILED DESCRIPTION

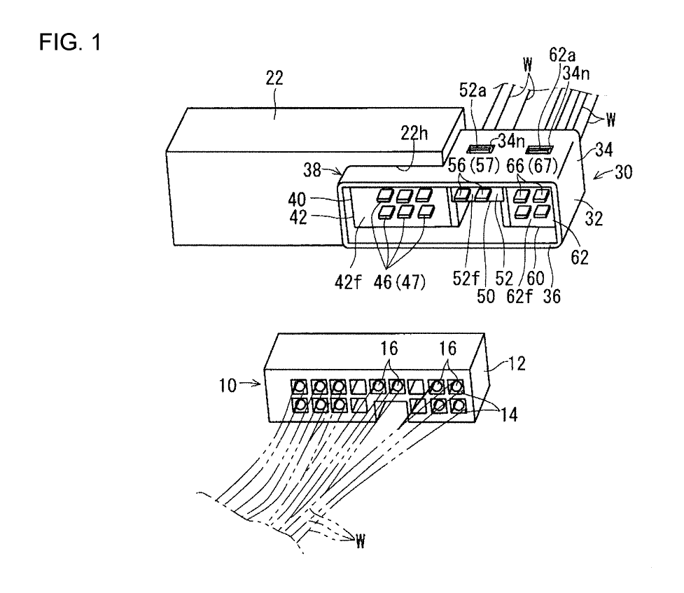

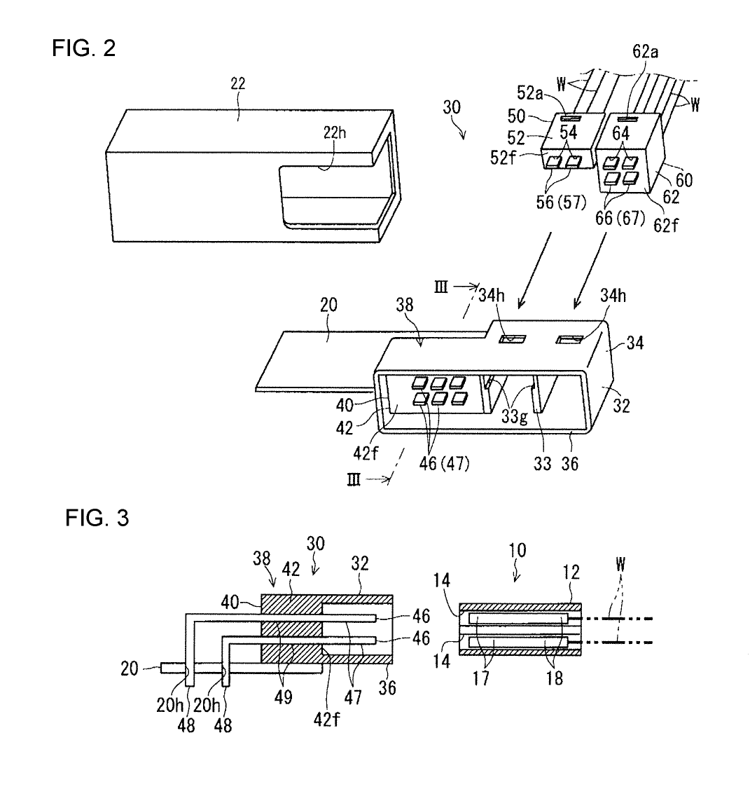

Hereinafter, a connector unit and a sub-connector with frame according to an embodiment are described. FIG. 1 is a schematic perspective view showing a connector unit 30, FIG. 2 is a schematic exploded perspective view of the connector unit 30, and FIG. 3 is a schematic section along of FIG. 2.

The connector unit 30 is to be connected to a mating connector 10 and includes a plurality of (here, three) sub-connectors 40, 50 and 60 and a frame 32.

The mating connector 10 includes a connector housing 12 and a plurality of female terminals 16.

The connector housing 12 is formed of resin or the like into a rectangular parallelepiped shape (here, a rectangular parallelepiped shape elongated in a lateral direction). Cavities 14 penetrate the connector housing 12 in a front-back direction thereof. Here, the connector housing 12 is formed with the cavities 14 in upper and lower stages arranged so that nine cavities 14 are formed in the upper stage and seven cavities 14 are formed in the lower stage. In the lower stage of the connector housing 12, seven cavities 14 are divided into three cavities 14 and four cavities 14 and an interval corresponding to two cavities 14 is provided between the three cavities 14 and the four cavities 14. A recess is formed in a part between the three cavities 14 and the four cavities 14 in a lower part of the connector housing 12.

The female terminal 16 is formed by appropriately press-forming a metal plate or the like and includes a wire connecting portion 18 and a female terminal portion 17, which are connected in a straight line.

An end part of a wire W is connected to the wire connecting portion 18, such as by crimping. Normally, the wire connecting portion 18 includes a crimping piece crimpable to a core of the end part of the wire W and the end part of the wire W and the wire connecting portion 18 are connected by caulking the crimping piece to the core.

The female terminal portion 17 is formed into a tubular shape (rectangular tube shape or cylindrical tube shape) and a male terminal portion 47, 57, 67 (to be described later) is inserted into the female terminal portion 17 for connection through a tip side opening of the female terminal portion 17.

The female terminal portions 17 are accommodated and held in all or some of the cavities 14 of the connector housing 12 (here, cavities 14 excluding third ones from right and fourth ones from left in FIG. 1). Vertical rows where the female terminal portions 17 are not accommodated and held correspond to intervals between the sub-connectors 40 and 50 and between the sub-connectors 50 and 60. Normally, the female terminal 16 is positioned and supported at a fixed position in the cavity 14, such as by locking the female terminal 16 by a locking piece (part also called a locking lance) that projects into the cavity 14, or by pressing a member, called a retainer, mounted in the connector housing 12 against the female terminal 16.

The female terminals 16 connected to the end parts of the respective wires W are accommodated and held in the cavities 14 of the connector housing 12. Specifically, the mating connector 10 is provided on the end parts of the plurality of wires W.

One sub-connector 40, out of the plurality of sub-connectors 40, 50 and 60, is formed integrally with a frame 32, and the other sub-connectors 50, 60 are separate from the frame 32. That is, the sub-connector 40 and the frame 32 are configured as a sub-connector with frame 38. Here, an example is described in which the sub-connector with frame 38 is of a type to be mounted and fixed to a mounting board 20.

The sub-connector with frame 38 includes the sub-connector 40 and the frame 32. The sub-connector 40 includes a connector housing 42 and male terminals 46. This sub-connector 40 is configured to be mountable on the mounting board 20.

The connector housing 42 is formed of resin or the like into a rectangular parallelepiped shape, and one principal surface thereof serves as a facing surface 42f that faces the connector housing 12.

The male terminal 46 is formed by appropriately press-forming a metal plate or the like and includes a male terminal portion 47, a board connecting portion 48 and an intermediate portion 49. The male terminal portion 47 is an elongated part formed into a long and thin plate or a pin (here, long and thin plate). The male terminal portion 47 is insertable into and connectable to the female terminal portion 17. The intermediate portion 49 is a long and thin part connected in a straight line to a base end part of the male terminal portion 47. Further, the board connecting portion 48 is formed into a long and thin shape extending from an end part of the intermediate portion 49 opposite to the male terminal portion 47 out of opposite end parts of the intermediate portion 49 while being perpendicular to the intermediate portion 49. Thus, the whole male terminal 46 is L-shaped in side view. The male terminal may also be straight.

The male terminal 46 is held in the connector housing 42 such that the male terminal portion 47 projects from the facing surface 42f of the connector housing 42 and the board connecting portion 48 projects from the back surface of the connector housing 42. Here, the connector housing 42 is formed by insert molding with parts of the intermediate portions 49 as insert parts.

Here, the male terminal portions 47 of a plurality of (here, six) male terminals 46 project from the facing surface 42f of the connector housing 42 with a plurality of (here, three) male terminal portions 47 aligned in each of upper and lower stages. The connector housing 42 itself (excluding a part by the frame 32 to be described later) is not formed with a part surrounding the facing surface 42f Thus, the male terminal portions 47 can be seen to be projecting from the connector housing 42 when the connector housing 42 itself is seen as a whole.

The board connecting portion 48 projects toward the bottom surface side of the connector housing 42 behind the connector housing 42. Note that the intermediate portions 49 and the board connecting portions 48 differ in length between the male terminals 46 incorporated in the upper stage of the connector housing 42 and the male terminals 46 incorporated in the lower stage so that the board connecting portions 18 do not contact each other. More particularly, the intermediate portions 49 and the board connecting portions 48 of the male terminals 46 in the upper stage circumvent the intermediate portions 49 and the board connecting portions 48 of the male terminals 46 in the lower stage.

With the sub-connector 40 disposed on the mounting board 20, tip parts of the board connecting portions 48 are inserted and connected to through holes 20h formed in the mounting board 20. In this way, the board connecting portions 48 of the male terminals 46 are connected electrically to a wiring pattern formed on the mounting board 20. The board connecting portions 48 and the wiring pattern may be connected electrically by soldering or by press-fitting the tip parts of the board connecting portions 48 into the through holes to be pressed against wirings formed on the inner surfaces of the through holes (also called press-fit terminals or the like).

The terminals integrated with the connector housing 42 as insert parts as described above preferably have as simple a shape as possible for the sake of processing. Also in this embodiment the male terminals 46 having a relatively simple shape are incorporated into the connector housing 42 rather than female terminals that have a relatively complicated shape.

Note that various electrical components such as semiconductor components are mounted on the mounting board 20 and the wiring pattern is connected to the electrical components mounted on the mounting board 20. Thus, the male terminals 46 are used as terminals for connecting an electrical circuit formed on the mounting board 20 to an external electrical device.

The connector housing 42 preferably is fixed to the mounting board 20 with the board connecting portions 48 of the male terminals 46 connected to the mounting board 20. The connector housing 42 and the mounting board 20 can be fixed, such as by screwing or by press-fitting a protrusion projecting on the connector housing 42 into the mounting board 20.

Further, the mounting board 20 is accommodated into a device casing 22. The device casing 22 is formed of resin, metal or the like into a box shape. The device casing may be configured by a combination of a casing body portion open on one side and a lid portion.

This device casing 22 is formed with an opening 22h for allowing the sub-connector 40 to project outward. The sub-connector 40 projects out from the device casing 22 through the opening 22h with the mounting board 20 fixed to the device casing 22 by screwing or the like.

Each of the sub-connectors 50, 60 includes a connector housing 52, 62 and male terminals 56, 66.

Each connector housing 52, 62 is formed of resin or the like into a rectangular parallelepiped shape. Each connector housing 52, 62 is formed with a plurality of cavities 54, 64 penetrating in a front-back direction thereof. Here, the connector housing 52 is formed with two cavities 54 in one stage. The connector housing 62 is formed with two cavities 64 in each of upper and lower stages.

The male terminal 56, 66 is formed by appropriately press-forming a metal plate or the like and includes a wire connecting portion (see FIG. 5 for a wire connecting portion 68 of the male terminal 66) and a male terminal portion 57, 67, which are connected in a straight line (see FIG. 5).

An end part of a wire W is connected to the wire connecting portion 68, such as by crimping. Normally, the wire connecting portion 68 includes a crimping piece crimpable to a core of the end part of the wire W and the end part of the wire W and the wire connecting portion 68 are connected by caulking the crimping piece to the core.

The male terminal portion 57, 67 is an elongated part formed into a long and thin plate or a pin (here, long and thin plate) and is insertable into and connectable to the female terminal portion 17.

The male terminals 56, 66 are accommodated and held in all or some of the cavities 54, 64 of the connector housing 52, 62. The male terminals 56, 66 are held by the connector housing 52, 62 so that the male terminal portions 57, 67 thereof project out from the connector housing 52, 62. Specifically, if one principal surface of the connector housing 52, 62 serves as a facing surface 52f, 62f facing the mating connector 10, the male terminal portions 57, 67 are oriented to project from this facing surface 52f, 62f. The connector housing 52, 62 itself is not formed with a part surrounding the facing surface 52f, 62f. Thus, the male terminal portions 57, 67 can be seen to be projecting from the connector housing 52, 62 when the connector housing 52, 62 is seen as a whole.

Note that, normally, each male terminal 56, 66 is positioned and supported at a fixed position in the cavity 54, 64, such as by locking the female terminal 56, 66 by a locking piece (part also called a locking lance) that is formed to project into the cavity 54, 64.

Note that the connector housing 52, 62 is formed with a protruding portion 52a, 62a for assembling and holding with the frame 32. Here, the protruding portion 52a, 62a is a projection formed on the upper surface of the connector housing 52, 62. The protruding portion 52a, 62a preferably is formed such that a height thereof is reduced gradually toward the facing surface 52f, 62f of the connector housing 52, 62.

Each of the sub-connectors 50, 60 is provided on a tip part of a bundle of the wires W.

The frame 32 includes a uniting frame portion 34 and a surrounding frame portion 36. As described above, the frame 32 is a resin molded article formed of resin or the like integrally to the connector housing 42.

The uniting frame portion 34 is configured to hold the plurality of sub-connectors 40, 50 and 60 in a united state with the male terminal portions 47, 57 and 67 of the plurality of sub-connectors 40, 50 and 60 facing in the same direction.

Here, the uniting frame portion 34 defines a quadrilateral frame to project toward one lateral side of the connector housing 42 (direction projecting from the device casing 22). The uniting frame portion 34 is partitioned by a partitioning portion 33 and the respective spaces partitioned by the partitioning portion 33 are formed into quadrilateral tubular spaces corresponding to the connector housings 52, 62. The respective spaces are formed adjacent to and side by side with the connector housing 42. Recessed parts 33g into which the connector housing 52 is fittable are formed on one side surface of the partitioning portion 33 and a part of the uniting frame portion 34 facing this one side surface. The connector housing 52 can be fit into the space on the side of the one side surface of the partitioning portion 33 from behind the uniting frame portion 34 (in a direction opposite to a projecting direction of the male terminals 46). At this time, the connector housing 52 can be accommodated and held at a fixed position by fitting both side parts of the connector housing 52 into the recessed parts 33g. The connector housing 62 similarly can be fit into the space on the side of the other side surface of the partitioning portion 33 from behind the uniting frame portion 34 (in the direction opposite to the projecting direction of the male terminals 46). Note that the partitioning portion 33 may be omitted. In such a case, the size of a uniting frame portion may be set such that one or a plurality of connectors can be fit tightly.

Further, the uniting frame portion 34 is formed with locking holes 34h as recessed parts into which the protruding portions 52a, 62a of the respective connector housings 52, 62 are fittable. As described above, the respective protruding portions 52a, 62a are fit into the respective locking holes 34h to be locked with the respective connector housings 52, 62 fit in the uniting frame portion 34 and the respective facing surfaces 42f, 52f and 62f aligned on the same plane. In this way, the connector housings 42, 52 and 62 are maintained in such a united state that the respective facing surfaces 42f, 52f and 62f are arranged on the same plane and the respective male terminal portions 47, 57 and 67 project in the same direction from the respective facing surfaces 42f, 52f and 62f. In this state, the respective male terminal portions 47, 57 and 67 are supported at such positions and in such an alignment as to be insertable into and connectable to the respective female terminals 16 of the mating connector 10.

The surrounding frame portion 36 is configured to surround the respective male terminal portions 47, 57 and 67 of the sub-connectors 40, 50 and 60. More specifically, the surrounding frame portion 36 is configured to cover spaces in front of the respective facing surfaces 42f, 52f and 62f by one quadrilateral enclosure without partitioning between these spaces. That is, the surrounding frame portion 36 covers three outer sides of the connector housings 42, 62 on both ends out of the plurality of connector housings 42, 52 and 62 and two outer sides of the connector housing 52 located in the middle, and do not partition between the respective connector housings 42, 52 and 62. Thus, one unpartitioned common space is formed in the surrounding frame portion 36 and the male terminal portions 47, 57 and 67 project into this space.

The surrounding frame portion 36 surrounds the male terminal portions 47, 57 and 67 projecting from the facing surfaces 42f, 52f and 62f. In this way, the surrounding frame portion 36 functions to protect the male terminal portions 47, particularly functions to suppress the bending and the like of the male terminal portions 47 due to contact with others in a state before the connector unit 30 is connected to the mating connector 10. Further, the surrounding frame portion 36 functions to guide the mating connector 10 such that the male terminal portions 47, 57 and 67 and the female terminal portions 17 are connected when connecting the connector unit 30 and the mating connector 10. Thus, a projecting dimension of the surrounding frame portion 36 from the facing surfaces 42f, 52f and 62f is preferably not shorter than projecting dimensions of the male terminal portions 47, 57 and 67 from the facing surfaces 42f, 52f and 62f.

In a state before the connector unit 30, as described above, is mounted into a vehicle or the like, each component constituting the connector unit 30 is handled as the sub-connector with frame 38 mounted or to be mounted on the mounting board 20 or the like or the sub-connector 50, 60 mounted or to be mounted on the wires W. The sub-connectors 50, 60 are used as components incorporated into the sub-connector with frame 38 in a state mounted as wiring members in the vehicle or the like and used for connection to the mating connector 10.

According to the connector unit 30 and the sub-connector with frame 38 thus configured, the plurality of sub-connectors 40, 50 and 60 including the male terminals 46, 56 and 66 can be configured into the connector unit 30 by being combined by the uniting frame portion 34 of the frame 32. At this time, the surrounding frame portion 36 surrounds the male terminal portions 47, 57 and 67 of the plurality of sub-connectors 40, 50 and 60 without partitioning them. This surrounding frame portion 36 can function to protect the male terminal portions 47, 57 and 67 and guide the mating connector 10. Thus, the mating connector 10 neither needs to have a split structure corresponding to the plurality of sub-connectors 40, 50 and 60, nor needs to have a dedicated design for accommodating partitions between the respective sub-connectors. In this way, restrictions on the mating connector 10 can be reduced and, for example, the connector housing 12 for general-purpose female terminals 16 can be used.

Further, since the frame 32 is formed integrally to one sub-connector 40 out of the sub-connectors 40, 50 and 60, the other sub-connectors 50, 60 can be incorporated into the frame 32 integrally formed to the sub-connector 40. In this way, the number of components and the number of assembling steps can be reduced.

Further, in this embodiment, the other sub-connectors 50, 60 can be united with the sub-connector 40 fixedly mounted on the mounting board 20. Thus, electrical connection reliability through the male terminals 46 of the sub-connector 40 can be improved. For example, if an ECU for controlling the operation of an airbag is mounted on the mounting board 20, a circuit of the mounting board 20 can be electrically connected to the female terminal 16 of the mating connector 10 through one male terminal 46 and the number of connection positions between the circuit on the mounting board 20 and the mating connector 10 can be reduced. Therefore the reliability of the wiring can be improved.

{Modifications}

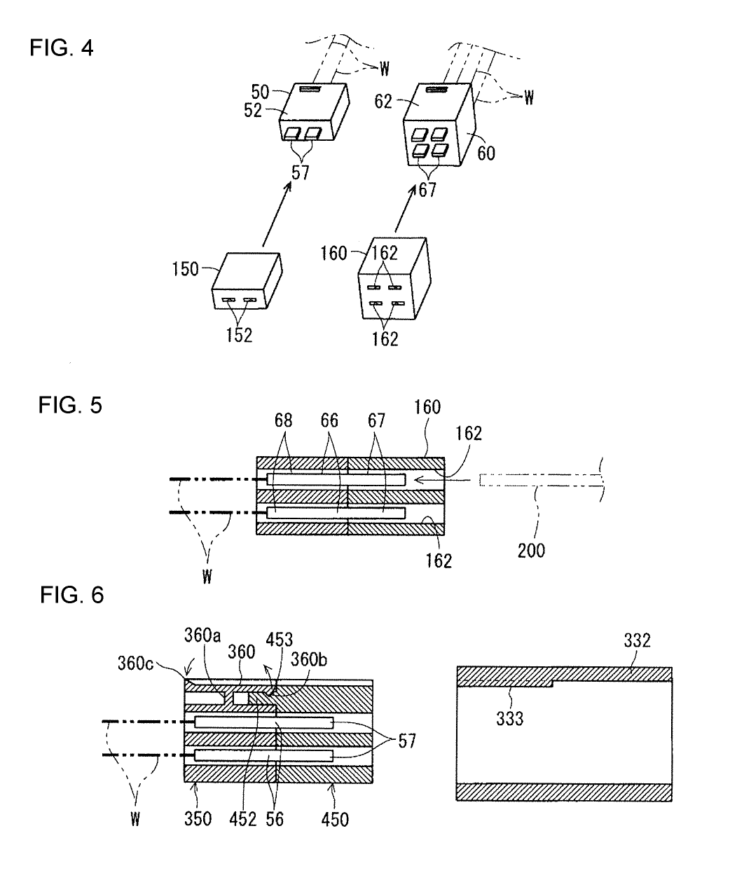

FIG. 4 is a schematic perspective view showing sub-connectors with caps according to a first modification, and FIG. 5 is a schematic section showing the sub-connector with cap.

Specifically, in the above sub-connectors 50, 60, the male terminal portions 57, 67 project from the connector housings 52, 62 in a state before being assembled with the sub-connector with frame 38. Thus, while the sub-connectors 50, 60 are handled, the male terminal portions 57, 67 may contact other parts.

Accordingly, in this first modification, caps 150, 160 for covering the male terminal portions 57, 67 projecting from the connector housings 52, 62 are mounted on the sub-connectors 50, 60.

The cap 150, 160 is a rectangular parallelepiped member formed of resin or the like and formed with holes 152, 162 at positions corresponding to the respective male terminal portions 57, 67. The holes 152, 162 are sized so that the male terminal portions 57, 67 are insertable therein. Preferably, the holes 152, 162 are sized so that the male terminal portions 57, 67 can be press-fit therein, and the detachment of the caps 150, 160 is suppressed by press-fitting the male terminal portions 57, 67 into the holes 152, 162.

Further, the holes 152, 162 are shaped so that an external checking terminal 200 (may be also called a probe pin) can come into contact. Here, the holes 152, 162 penetrate through the caps 150, 160 and the terminal 200 can be brought into contact with the male terminal portions 57, 67 by being inserted through openings on tip sides of the caps 150, 160. This enables a continuity check or the like for the male terminals 56, 66 of the sub-connectors 50, 60 to be carried out with the caps 150, 160 mounted on the sub-connectors 50, 60. Further, the male terminal portions 57, 67 can be protected by the caps 150, 160 in a state before the sub-connectors 50, 60 are incorporated into the frame 32.

Further, when the sub-connectors 50, 60 are incorporated into the frame 32, the male terminal portions 57, 67 are protected by the surrounding frame portion 36 so that the caps 150, 160 are not necessary.

Accordingly, a preferable configuration is such that a cap 450 corresponding to the cap 150 can be detached when a sub-connector 350 corresponding to the sub-connector 50 is incorporated into a frame 332 corresponding to the frame 32 as in a second modification shown in FIG. 6.

In the second modification, an extending piece 452 for locking projects on the cap 450. A locking piece 360 for locking is provided on the side of the sub-connector 350. When the sub-connector 350 is fit into the frame 332, a pressing protrusion 333 of the frame 332 presses the locking piece 360 to release locking between the extending piece 452 and the locking piece 360. As a result, a locked state of the cap 450 to the sub-connector 350 is released and the cap 450 can be detached easily.

More specifically, the extending piece 452 is provided on the cap 450 to project toward the sub-connector 350. The extending piece 452 is formed with a receiving recess 453.

The locking piece 360 is provided in a widthwise part of a top part of the sub-connector 350. The locking piece 360 is elongated along a front-back direction of the sub-connector 350 (extending direction of the male terminal portions 57) and pivotally supported via a supporting portion 360a in an intermediate part in an extending direction thereof. An inward facing part of a tip part of the locking piece 360 is formed with a lock protrusion 360b that can fit into the above-described receiving recess 453 and a pressed portion 360c projects on an outward facing part of a base end part of the locking piece 360.

Further, the pressing protrusion 333 capable of pressing the pressed portion 360c projects at a position corresponding to the pressed portion 360c on the inner peripheral surface of the frame 332.

When mounting the cap 450 on the sub-connector 350, the extending piece 452 is inserted below the inward facing part of the tip part of the locking piece 360 and the lock protrusion 360b is fit into the receiving recess 453. In this way, the cap 450 is held with detachment from the sub-connector 350 suppressed. Note that the male terminal portions 57 are inserted loosely into holes of the cap 450.

When the sub-connector 350 is fit into the frame 332, the pressing protrusion 333 presses the pressed portion 360c inwardly of the sub-connector 350. Then, the locking piece 360 is pivoted with a supported position by the supporting portion 360a as a fulcrum and the tip part of the locking piece 360 is displaced out. In this way, the lock protrusion 360b comes out of the receiving recess 453 and the cap 450 can be detached easily from the sub-connector 350. In this state, the cap 450 preferably is turned down to be detached.

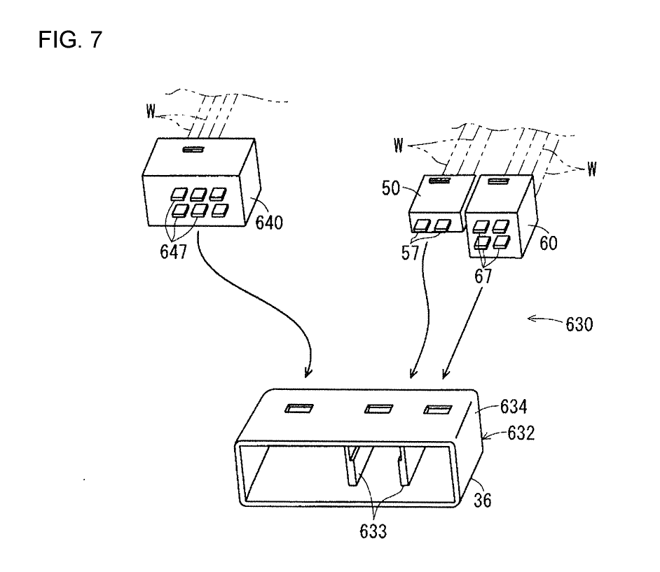

FIG. 7 is an exploded schematic perspective view showing a connector unit 630 according to a third modification.

Specifically, an example has been described above in which the sub-connector 40 is formed integrally to the frame 32. However, all sub-connectors 640, 50 and 60 of the connector unit 630 may be separate from a frame 632, as in this third modification. Specifically, similar to the sub-connector 60, the sub-connector 640 is separate from the frame 632 and includes male terminal portions 647 connected to end parts of wires W. Further, the frame 632 corresponding to the frame 32 includes a uniting frame portion 634 and a surrounding frame portion 36.

The uniting frame portion 643 differs from the above uniting frame portion 34 in holding the sub-connectors 640, 50 and 60 in the united state. Specifically, the uniting frame portion 634 is formed into a quadrilateral frame and the interior is divided into a plurality of (here, three) spaces by partitioning portions 633. The sub-connectors 640, 50 and 60 are accommodated into the respective divided accommodation spaces. In this state, male terminal portions 647, 57 and 67 of the sub-connectors 640, 50 and 60 are facing in the same direction. The surrounding frame portion 36 extends farther than the uniting frame portion 634 and surrounds the respective male terminal portions 647, 57 and 67 of the sub-connectors 640, 50 and 60 without partitioning them.

The connector unit 630 according to this third modification is effective in collectively connecting the sub-connectors 640, 50 and 60 connected to the tips of a plurality of wiring harnesses to a connector of another wiring harness. For example, a harness for driving a power seat, a harness for a sensor for detecting the weight of a passenger, a harness for airbag, a harness for audio and the like may be incorporated into a seat of a vehicle. If these harnesses are connected to a floor harness of the vehicle via individual connectors, a connecting operation is cumbersome. Accordingly, if the connector unit 630 is applied, the respective sub-connectors can be connected collectively to a connector of the floor harness.

Note that the respective configurations described in the above embodiment and modifications can be appropriately combined unless these configurations are inconsistent with each other.

Although this invention has been described in detail above, the above description is illustrative in all aspects and this invention is not limited thereby. It should be appreciated that unillustrated numerous modifications can be made without departing from the scope of this invention.

### LIST OF REFERENCE SIGNS

W wire
10 mating connector
42, 52, 62 connector housing
54, 64 cavity
16 female terminal
17 female terminal portion
20 mounting board
30, 630 connector unit
32, 332, 632 frame
34, 634 uniting frame portion
36 surrounding frame portion
38 sub-connector with frame
40, 50, 60, 350, 640 sub-connector
42f, 52f, 62f facing surface
46, 56, 66 male terminal
47, 57, 67, 647 male terminal portion
150, 160, 450 cap
152, 162 hole

1. A connector unit to be connected to a mating connector, comprising:
a plurality of sub-connectors each including a connector housing and a male terminal held by the connector housing with a male terminal portion projecting out from the connector housing; and
a frame including a uniting frame portion for holding the plurality of sub-connectors in a united state with the male terminal portions of the plurality of sub-connectors facing in the same direction and a surrounding frame portion for surrounding the male terminal portions of the plurality of sub-connectors,
wherein:
the frame is integrally formed to any one of the plurality of sub-connectors;
the sub-connector integrally formed to the frame, out of the plurality of sub-connectors, is mountable on a mounting board; and
the male terminals held by those of the plurality of sub-connectors not integrally formed to the frame are connected to wires.

2. (canceled)

3 (canceled)

4. (canceled)

5 (canceled)

6. A connector unit to be connected to a mating connector, comprising:
at least first and second sub-connectors, each of the sub-connectors including a connector housing and at least one male terminal held by the connector housing so that a male terminal portion of each male terminal projects out from the respective connector housing, the male terminals held by the second sub-connector are connected to wires, and the first sub-connector being configured to be mountable on a mounting board; and
a frame including a uniting frame portion for holding the plurality of sub-connectors in a united state with the male terminal portions of the sub-connectors facing in a common direction and a surrounding frame portion for surrounding the male terminal portions of the sub-connectors, the frame being integral to the first sub-connector.
